(19) United States
(12) Patent Application Publication
(10) Pub. No.: US 2009/0040946 A1
(43) Pub. Date: Feb. 12, 2009

(54) Executing an Allgather Operation on a Parallel Computer

(76) Inventors: Charles J. Archer, Rochester, MN (US); Ahmad A. Faraj, Rochester, MN (US)

Correspondence Address: IBM (ROC-BLF), C/O BIGGERS & OHANIAN, LLP, P.O. BOX 1469, AUSTIN, TX, 78767-1469, US

(21) Appl. No.: 11/834,153

(22) Filed: Aug. 6, 2007

(51) Int. Cl. H04L 12/28

(52) U.S. Cl. 370/255

(57) ABSTRACT

Methods, apparatus, and products are disclosed for executing an allgather operation on a parallel computer that includes a plurality of compute nodes organized into at least one operational group of compute nodes for collective parallel operations, each compute node in the operational group assigned a unique rank, that includes: determining a contention-free logical ring topology for the compute nodes in the operational group; configuring, for each compute node in the operational group according to the contention-free logical ring topology, a routing table to specify a forwarding path to the next compute node in the logical ring topology; and repeatedly, for each compute node in the operational group until each compute node has received contributions for all of the other compute nodes in the operational group, forwarding a contribution for the allgather operation to the next compute node in the logical ring topology along the forwarding path.

### STATEMENT REGARDING FEDERALLY SPONSORED RESEARCH OR DEVELOPMENT

This invention was made with Government support under Contract No. B554331 awarded by the Department of Energy. The Government has certain rights in this invention.

### BACKGROUND OF THE INVENTION

1. Field of the Invention

The field of the invention is data processing, or, more specifically, methods, apparatus, and products for executing an allgather operation on a parallel computer.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Parallel computing is an area of computer technology that has experienced advances. Parallel computing is the simultaneous execution of the same task (split up and specially adapted) on multiple processors in order to obtain results faster. Parallel computing is based on the fact that the process of solving a problem usually can be divided into smaller tasks, which may be carried out simultaneously with some coordination.

Parallel computers execute parallel algorithms. A parallel algorithm can be split up to be executed a piece at a time on many different processing devices, and then put back together again at the end to get a data processing result. Some algorithms are easy to divide up into pieces. Splitting up the job of checking all of the numbers from one to a hundred thousand to see which are primes could be done, for example, by assigning a subset of the numbers to each available processor, and then putting the list of positive results back together. In this specification, the multiple processing devices that execute the individual pieces of a parallel program are referred to as ‘compute nodes.’ A parallel computer is composed of compute nodes and other processing nodes as well, including, for example, input/output (‘I/O’) nodes, and service nodes.

Parallel algorithms are valuable because it is faster to perform some kinds of large computing tasks via a parallel algorithm than it is via a serial (non-parallel) algorithm, because of the way modern processors work. It is far more difficult to construct a computer with a single fast processor than one with many slow processors with the same throughput. There are also certain theoretical limits to the potential speed of serial processors. On the other hand, every parallel algorithm has a serial part and so parallel algorithms have a saturation point. After that point adding more processors does not yield any more throughput but only increases the overhead and cost.

Parallel algorithms are designed also to optimize one more resource the data communications requirements among the nodes of a parallel computer. There are two ways parallel processors communicate, shared memory or message passing. Shared memory processing needs additional locking for the data and imposes the overhead of additional processor and bus cycles and also serializes some portion of the algorithm.

Message passing processing uses high-speed data communications networks and message buffers, but this communication adds transfer overhead on the data communications networks as well as additional memory need for message buffers and latency in the data communications among nodes. Designs of parallel computers use specially designed data communications links so that the communication overhead will be small but it is the parallel algorithm that decides the volume of the traffic.

Many data communications network architectures are used for message passing among nodes in parallel computers. Compute nodes may be organized in a network as a ‘torus’ or ‘mesh,’ for example. Also, compute nodes may be organized in a network as a tree. A torus network connects the nodes in a three-dimensional mesh with wrap around links. Every node is connected to its six neighbors through this torus network, and each node is addressed by its x, y, z coordinate in the mesh. In a tree network, the nodes typically are connected into a binary tree: each node has a parent, and two children (although some nodes may only have zero children or one child, depending on the hardware configuration). In computers that use a torus and a tree network, the two networks typically are implemented independently of one another, with separate routing circuits, separate physical links, and separate message buffers.

A torus network lends itself to point to point operations, but a tree network typically is inefficient in point to point communication. A tree network, however, does provide high bandwidth and low latency for certain collective operations, message passing operations where all compute nodes participate simultaneously, such as, for example, an allgather operation. An allgather operation is a collective operation on an operational group of compute nodes that concatenates segments of data stored on each compute node in rank order and provides the entire concatenation results to all of the compute nodes in the operational group. Because thousands of nodes may participate in collective operations on a parallel computer, executing an allgather operation on a parallel computer is always a challenge. A typical prior art algorithm for carrying out an allgather is for each computer node in the operational group to broadcast its contribution of data to all the compute nodes in the operational group. If the group is large, and such groups may contain thousands of compute nodes, then the data communications cost of such an algorithm is substantial. As such, readers will appreciate any improvements in executing an allgather operation on a parallel computer.

### SUMMARY OF THE INVENTION

Methods, apparatus, and products are disclosed for executing an allgather operation on a parallel computer, the parallel computer including a plurality of compute nodes, the compute nodes organized into at least one operational group of compute nodes for collective parallel operations, each compute node in the operational group assigned a unique rank, that includes: determining a contention-free logical ring topology for the compute nodes in the operational group; configuring, for each compute node in the operational group according to the contention-free logical ring topology, a routing table to specify a forwarding path to the next compute node in the contention-free logical ring topology; and repeatedly, for each compute node in the operational group until each compute node in the operational group has received contributions for all of the other compute nodes in the operational group, forwarding a contribution for the allgather operation to the next compute node in the contention-free logical ring topology along the forwarding path specified in that compute node's routing table.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 illustrates an exemplary parallel computer for executing an allgather operation according to embodiments of the present invention.

FIG. 2 sets forth a block diagram of an exemplary compute node useful in a parallel computer capable of executing an allgather operation according to embodiments of the present invention.

FIG. 3A illustrates an exemplary Point To Point Adapter useful in a parallel computer capable of executing an allgather operation according to embodiments of the present invention.

FIG. 3B illustrates an exemplary Global Combining Network Adapter useful in a parallel computer capable of executing an allgather operation according to embodiments of the present invention.

FIG. 4 sets forth a line drawing illustrating an exemplary data communications network optimized for point to point operations useful in a parallel computer capable of executing an allgather operation according to embodiments of the present invention.

FIG. 5 sets forth a line drawing illustrating an exemplary data communications network optimized for collective operations useful in a parallel computer capable of executing an allgather operation according to embodiments of the present invention.

FIG. 6A sets forth a line drawing illustrating an exemplary tree network useful in a parallel computer capable of executing an allgather operation according to embodiments of the present invention.

FIG. 6B sets forth a line drawing illustrating an exemplary contention-free logical ring topology useful in a parallel computer capable of executing an allgather operation according to embodiments of the present invention.

FIGS. 7A-G set forth line drawings illustrating exemplary compute nodes that each repeatedly forward a contribution for an allgather operation to the next compute node in the contention-free logical ring topology until each compute node in the operational group has received contributions for all of the other compute nodes in the operational group according to embodiments of the present invention.

FIG. 8 sets forth a flow chart illustrating an exemplary method for executing an allgather operation on a parallel computer according to the present invention.

### DETAILED DESCRIPTION OF EXEMPLARY EMBODIMENTS

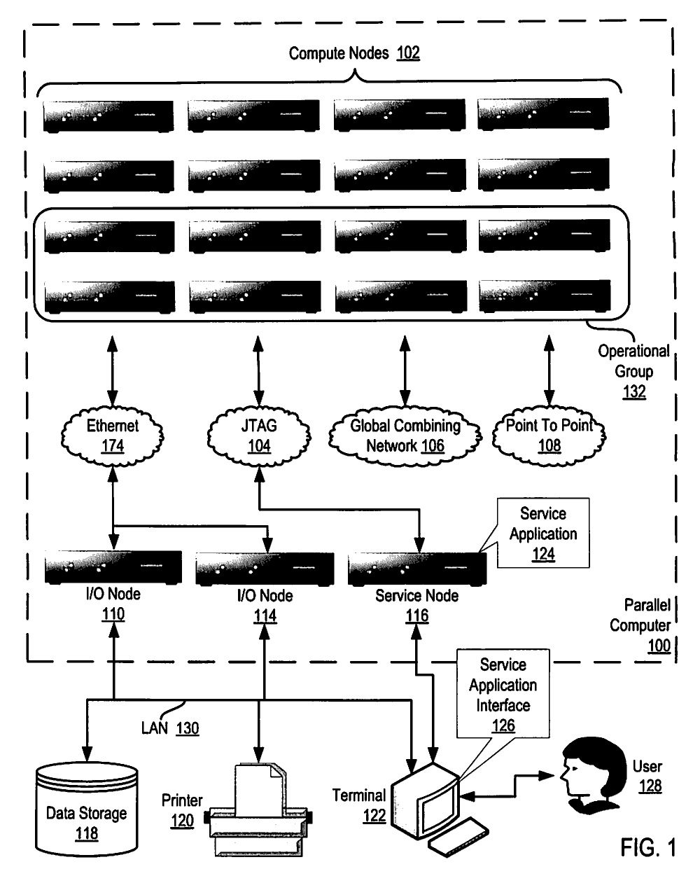

Exemplary methods, apparatus, and computer program products for executing an allgather operation on a parallel computer according to embodiments of the present invention are described with reference to the accompanying drawings, beginning with FIG. 1. FIG. 1 illustrates an exemplary parallel computer for executing an allgather operation according to embodiments of the present invention. The system of FIG. 1 includes a parallel computer (100), non-volatile memory for the computer in the form of data storage device (118), an output device for the computer in the form of printer (120), and an input/output device for the computer in the form of computer terminal (122). Parallel computer (100) in the example of FIG. 1 includes a plurality of compute nodes (102).

The compute nodes (102) are coupled for data communications by several independent data communications networks including a high speed Ethernet network (174), a Joint Test Action Group (‘JTAG’) network (104), a global combining network (106) which is optimized for collective operations, and a torus network (108) which is optimized point to point operations. The global combining network (106) is a data communications network that includes data communications links connected to the compute nodes so as to organize the compute nodes as a tree. Each data communications network is implemented with data communications links among the compute nodes (102). The data communications links provide data communications for parallel operations among the compute nodes of the parallel computer.

In addition, the compute nodes (102) of parallel computer are organized into at least one operational group (132) of compute nodes for collective parallel operations on parallel computer (100). An operational group of compute nodes is the set of compute nodes upon which a collective parallel operation executes. Collective operations are implemented with data communications among the compute nodes of an operational group. Collective operations are those functions that involve all the compute nodes of an operational group. A collective operation is an operation, a message-passing computer program instruction that is executed simultaneously, that is, at approximately the same time, by all the compute nodes in an operational group of compute nodes. Such an operational group may include all the compute nodes in a parallel computer (100) or a subset all the compute nodes. Collective operations are often built around point to point operations. A collective operation requires that all processes on all compute nodes within an operational group call the same collective operation with matching arguments. A ‘broadcast’ is an example of a collective operation for moving data among compute nodes of an operational group. A ‘reduce’ operation is an example of a collective operation that executes arithmetic or logical functions on data distributed among the compute nodes of an operational group. An operational group may be implemented as, for example, an MPI ‘communicator.’

‘MPI’ refers to ‘Message Passing Interface,’ a prior art parallel communications library, a module of computer program instructions for data communications on parallel computers. Examples of prior-art parallel communications libraries that may be improved for use with systems according to embodiments of the present invention include MPI and the ‘Parallel Virtual Machine’ (‘PVM’) library. PVM was developed by the University of Tennessee, The Oak Ridge National Laboratory, and Emory University. MPI is promulgated by the MPI Forum, an open group with representatives from many organizations that define and maintain the MPI standard. MPI at the time of this writing is a de facto standard for communication among compute nodes running a parallel program on a distributed memory parallel computer. This specification sometimes uses MPI terminology for ease of explanation, although the use of MPI as such is not a requirement or limitation of the present invention.

Some collective operations have a single originating or receiving process running on a particular compute node in an operational group. For example, in a ‘broadcast’ collective operation, the process on the compute node that distributes the data to all the other compute nodes is an originating process. In a ‘gather’ operation, for example, the process on the compute node that received all the data from the other compute nodes is a receiving process. The compute node on which such an originating or receiving process runs is referred to as a logical root.

Most collective operations are variations or combinations of four basic operations: broadcast, gather, scatter, and reduce. The interfaces for these collective operations are defined in the MPI standards promulgated by the MPI Forum. Algorithms for executing collective operations, however, are not defined in the MPI standards. In a broadcast operation, all processes specify the same root process, whose buffer contents will be sent. Processes other than the root specify receive buffers. After the operation, all buffers contain the message from the root process.

In a scatter operation, the logical root divides data on the root into segments and distributes a different segment to each compute node in the operational group. In scatter operation, all processes typically specify the same receive count. The send arguments are only significant to the root process, whose buffer actually contains sendcount*N elements of a given data type, where N is the number of processes in the given group of compute nodes. The send buffer is divided and dispersed to all processes (including the process on the logical root). Each compute node is assigned a sequential identifier termed a ‘rank.’ After the operation, the root has sent sendcount data elements to each process in increasing rank order. Rank 0 receives the first sendcount data elements from the send buffer. Rank 1 receives the second sendcount data elements from the send buffer, and so on.

A gather operation is a many-to-one collective operation that is a complete reverse of the description of the scatter operation. That is, a gather is a many-to-one collective operation in which elements of a datatype are gathered from the ranked compute nodes into a receive buffer in a root node.

A reduce operation is also a many-to-one collective operation that includes an arithmetic or logical function performed on two data elements. All processes specify the same ‘count’ and the same arithmetic or logical function. After the reduction, all processes have sent count data elements from computer node send buffers to the root process. In a reduction operation, data elements from corresponding send buffer locations are combined pair-wise by arithmetic or logical operations to yield a single corresponding element in the root process's receive buffer. Application specific reduction operations can be defined at runtime. Parallel communications libraries may support predefined operations. MPI, for example, provides the following pre-defined reduction operations:

| | |
|---|---|
| MPI_MAX | maximum |
| MPI_MIN | minimum |
| MPI_SUM | sum |
| MPI_PROD | product |
| MPI_LAND | logical and |
| MPI_BAND | bitwise and |
| MPI_LOR | logical or |
| MPI_BOR | bitwise or |
| MPI_LXOR | logical exclusive or |
| MPI_BXOR | bitwise exclusive or |

In addition to compute nodes, the parallel computer (100) includes input/output (‘I/O’) nodes (110, 114) coupled to compute nodes (102) through one of the data communications networks (174). The I/O nodes (110, 114) provide I/O services between compute nodes (102) and I/O devices (118, 120, 122). I/O nodes (110, 114) are connected for data communications I/O devices (118, 120, 122) through local area network (‘LAN’) (130). The parallel computer (100) also includes a service node (116) coupled to the compute nodes through one of the networks (104). Service node (116) provides service common to pluralities of compute nodes, loading programs into the compute nodes, starting program execution on the compute nodes, retrieving results of program operations on the computer nodes, and so on. Service node (116) runs a service application (124) and communicates with users (128) through a service application interface (126) that runs on computer terminal (122).

As described in more detail below in this specification, the system of FIG. 1 operates generally for executing an allgather operation on a parallel computer according to embodiments of the present invention. The parallel computer includes a plurality of compute nodes that are organized into at least one operational group of compute nodes for collective parallel operations. Each compute node in the operational group is assigned a unique rank. The system of FIG. 1 operates generally for executing an allgather operation on a parallel computer according to embodiments of the present invention by: determining a contention-free logical ring topology for the compute nodes in the operational group; configuring, for each compute node in the operational group according to the contention-free logical ring topology, a routing table to specify a forwarding path to the next compute node in the contention-free logical ring topology; and repeatedly, for each compute node in the operational group until each compute node in the operational group has received contributions for all of the other compute nodes in the operational group, forwarding a contribution for the allgather operation to the next compute node in the contention-free logical ring topology along the forwarding path specified in that compute node's routing table.

A logical ring topology is a network topology in which each of the nodes of the network is logically connected to two other nodes in the network and with the first and last nodes being connected to each other, forming a ring. All data that is transmitted between nodes in the network travels from one node to the next node in a circular manner and the data typically only flows in a single direction. A logical ring topology is referred to as ‘contention-free’ when each physical link connecting the compute nodes in the logical ring topology is only used for data communications by a single pair of compute nodes in one direction at a time.

The arrangement of nodes, networks, and I/O devices making up the exemplary system illustrated in FIG. 1 are for explanation only, not for limitation of the present invention. Data processing systems capable of executing an allgather operation on a parallel computer according to embodiments of the present invention may include additional nodes, networks, devices, and architectures, not shown in FIG. 1, as will occur to those of skill in the art. Although the parallel computer (100) in the example of FIG. 1 includes sixteen compute nodes (102), readers will note that parallel computers capable of determining when a set of compute nodes participating in a barrier operation are ready to exit the barrier operation according to embodiments of the present invention may include any number of compute nodes. In addition to Ethernet and JTAG, networks in such data processing systems may support many data communications protocols including for example TCP (Transmission Control Protocol), IP (Internet Protocol), and others as will occur to those of skill in the art. Various embodiments of the present invention may be implemented on a variety of hardware platforms in addition to those illustrated in FIG. 1.

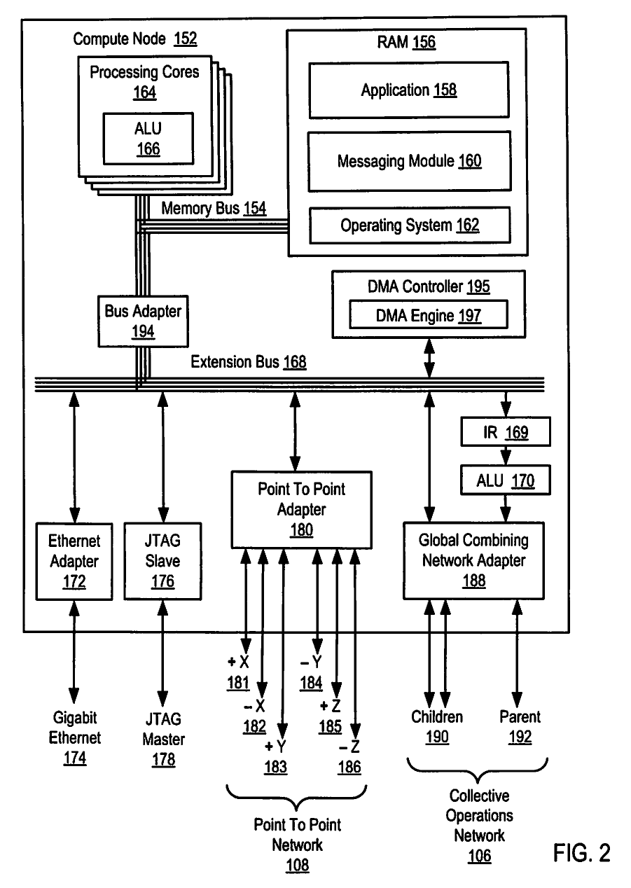

Executing an allgather operation according to embodiments of the present invention may be generally implemented on a parallel computer that includes a plurality of compute nodes. In fact, such computers may include thousands of such compute nodes. Each compute node is in turn itself a kind of computer composed of one or more computer processors (or processing cores), its own computer memory, and its own input/output adapters. For further explanation, therefore, FIG. 2 sets forth a block diagram of an exemplary compute node useful in a parallel computer capable of executing an allgather operation according to embodiments of the present invention. The compute node (152) of FIG. 2 includes one or more processing cores (164) as well as random access memory (‘RAM’) (156). The processing cores (164) are connected to RAM (156) through a high-speed memory bus (154) and through a bus adapter (194) and an extension bus (168) to other components of the compute node (152). Stored in RAM (156) is an application program (158), a module of computer program instructions that carries out parallel, user-level data processing using parallel algorithms.

Also stored in RAM (156) is a messaging module (160), a library of computer program instructions that carry out parallel communications among compute nodes, including point to point operations as well as collective operations. Application program (158) executes collective operations by calling software routines in the messaging module (160). A library of parallel communications routines may be developed from scratch for use in systems according to embodiments of the present invention, using a traditional programming language such as the C programming language, and using traditional programming methods to write parallel communications routines that send and receive data among nodes on two independent data communications networks. Alternatively, existing prior art libraries may be improved to operate according to embodiments of the present invention. Examples of prior-art parallel communications libraries include the ‘Message Passing Interface’ (‘MPI’) library and the ‘Parallel Virtual Machine’ (‘PVM’) library.

Also stored in RAM (156) is an operating system (162), a module of computer program instructions and routines for an application program's access to other resources of the compute node. It is typical for an application program and parallel communications library in a compute node of a parallel computer to run a single thread of execution with no user login and no security issues because the thread is entitled to complete access to all resources of the node. The quantity and complexity of tasks to be performed by an operating system on a compute node in a parallel computer therefore are smaller and less complex than those of an operating system on a serial computer with many threads running simultaneously. In addition, there is no video I/O on the compute node (152) of FIG. 2, another factor that decreases the demands on the operating system. The operating system may therefore be quite lightweight by comparison with operating systems of general purpose computers, a pared down version as it were, or an operating system developed specifically for operations on a particular parallel computer. Operating systems that may usefully be improved, simplified, for use in a compute node include UNIX™, Linux™, Microsoft XP™, AIX™, IBM's i5/OS™, and others as will occur to those of skill in the art.

The exemplary compute node (152) of FIG. 2 includes several communications adapters (172, 176, 180, 188) for implementing data communications with other nodes of a parallel computer. Such data communications may be carried out serially through RS-232 connections, through external buses such as Universal Serial Bus (‘USB’), through data communications networks such as IP networks, and in other ways as will occur to those of skill in the art. Communications adapters implement the hardware level of data communications through which one computer sends data communications to another computer, directly or through a network. Examples of communications adapters useful in systems for executing an allgather operation on a parallel computer according to embodiments of the present invention include modems for wired communications, Ethernet (IEEE 802.3) adapters for wired network communications, and 802.11b adapters for wireless network communications.

The data communications adapters in the example of FIG. 2 include a Gigabit Ethernet adapter (172) that couples example compute node (152) for data communications to a Gigabit Ethernet (174). Gigabit Ethernet is a network transmission standard, defined in the IEEE 802.3 standard, that provides a data rate of 1 billion bits per second (one gigabit). Gigabit Ethernet is a variant of Ethernet that operates over multimode fiber optic cable, single mode fiber optic cable, or unshielded twisted pair.

The data communications adapters in the example of FIG. 2 includes a JTAG Slave circuit (176) that couples example compute node (152) for data communications to a JTAG Master circuit (178). JTAG is the usual name used for the IEEE 1149.1 standard entitled Standard Test Access Port and Boundary-Scan Architecture for test access ports used for testing printed circuit boards using boundary scan. JTAG is so widely adapted that, at this time, boundary scan is more or less synonymous with JTAG. JTAG is used not only for printed circuit boards, but also for conducting boundary scans of integrated circuits, and is also useful as a mechanism for debugging embedded systems, providing a convenient “back door” into the system. The example compute node of FIG. 2 may be all three of these: It typically includes one or more integrated circuits installed on a printed circuit board and may be implemented as an embedded system having its own processor, its own memory, and its own I/O capability. JTAG boundary scans through JTAG Slave (176) may efficiently configure processor registers and memory in compute node (152) for use in executing an allgather operation on a parallel computer according to embodiments of the present invention.

The data communications adapters in the example of FIG. 2 includes a Point To Point Adapter (180) that couples example compute node (152) for data communications to a network (108) that is optimal for point to point message passing operations such as, for example, a network configured as a three-dimensional torus or mesh. Point To Point Adapter (180) provides data communications in six directions on three communications axes, x, y, and z, through six bidirectional links: +x (181), −x (182), +y (183), −y (184), +z (185), and −z (186).

The data communications adapters in the example of FIG. 2 includes a Global Combining Network Adapter (188) that couples example compute node (152) for data communications to a network (106) that is optimal for collective message passing operations on a global combining network configured, for example, as a binary tree. The Global Combining Network Adapter (188) provides data communications through three bidirectional links: two to children nodes (190) and one to a parent node (192).

Example compute node (152) includes two arithmetic logic units (‘ALUs’). ALU (166) is a component of each processing core (164), and a separate ALU (170) is dedicated to the exclusive use of Global Combining Network Adapter (188) for use in performing the arithmetic and logical functions of reduction operations. Computer program instructions of a reduction routine in parallel communications library (160) may latch an instruction for an arithmetic or logical function into instruction register (169). When the arithmetic or logical function of a reduction operation is a ‘sum’ or a ‘logical or,’ for example, Global Combining Network Adapter (188) may execute the arithmetic or logical operation by use of ALU (166) in processor (164) or, typically much faster, by use dedicated ALU (170).

The example compute node (152) of FIG. 2 includes a direct memory access (‘DMA’) controller (195), which is computer hardware for direct memory access and a DMA engine (197), which is computer software for direct memory access. In the example of FIG. 2, the DMA engine (197) is configured in computer memory of the DMA controller (195). Direct memory access includes reading and writing to memory of compute nodes with reduced operational burden on the central processing units (164). A DMA transfer essentially copies a block of memory from one location to another, typically from one compute node to another. While the CPU may initiate the DMA transfer, the CPU does not execute it.

As mentioned above, the compute node (152) of FIG. 2 is useful in a parallel computer capable of executing an allgather operation according to embodiments of the present invention. Such a parallel computer according to embodiments of the present invention includes a plurality of compute nodes that are organized into at least one operational group of compute nodes for collective parallel operations. Each compute node in the operational group is assigned a unique rank. The parallel computer operates generally for executing an allgather operation according to embodiments of the present invention by: determining a contention-free logical ring topology for the compute nodes in the operational group; configuring, for each compute node in the operational group according to the contention-free logical ring topology, a routing table to specify a forwarding path to the next compute node in the contention-free logical ring topology; and repeatedly, for each compute node in the operational group until each compute node in the operational group has received contributions for all of the other compute nodes in the operational group, forwarding a contribution for the allgather operation to the next compute node in the contention-free logical ring topology along the forwarding path specified in that compute node's routing table.

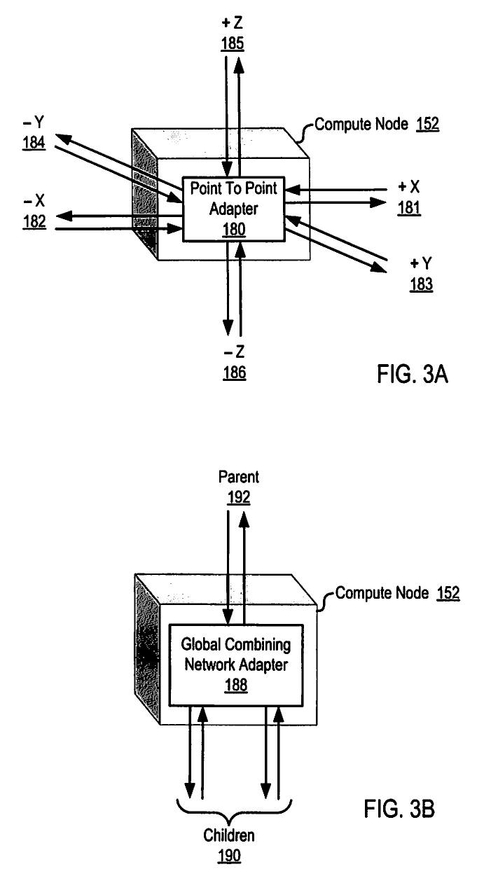

For further explanation, FIG. 3A illustrates an exemplary Point To Point Adapter (180) useful in a parallel computer capable of executing an allgather operation according to embodiments of the present invention. Point To Point Adapter (180) is designed for use in a data communications network optimized for point to point operations, a network that organizes compute nodes in a three-dimensional torus or mesh. Point To Point Adapter (180) in the example of FIG. 3A provides data communication along an x-axis through four unidirectional data communications links, to and from the next node in the −x direction (182) and to and from the next node in the +x direction (181). Point To Point Adapter (180) also provides data communication along a y-axis through four unidirectional data communications links, to and from the next node in the −y direction (184) and to and from the next node in the +y direction (183). Point To Point Adapter (180) in FIG. 3A also provides data communication along a z-axis through four unidirectional data communications links, to and from the next node in the −z direction (186) and to and from the next node in the +z direction (185).

For further explanation, FIG. 3B illustrates an exemplary Global Combining Network Adapter (188) useful in a parallel computer capable of executing an allgather operation according to embodiments of the present invention. Global Combining Network Adapter (188) is designed for use in a network optimized for collective operations, a network that organizes compute nodes of a parallel computer in a binary tree. Global Combining Network Adapter (188) in the example of FIG. 3B provides data communication to and from two children nodes through four unidirectional data communications links (190). Global Combining Network Adapter (188) also provides data communication to and from a parent node through two unidirectional data communications links (192).

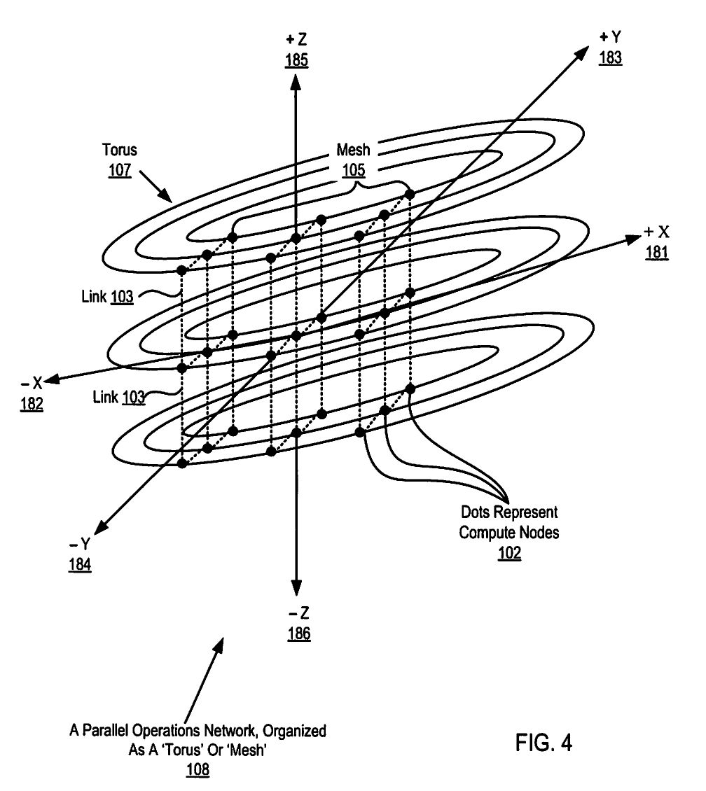

For further explanation, FIG. 4 sets forth a line drawing illustrating an exemplary data communications network (108) optimized for point to point operations useful in a parallel computer capable of executing an allgather operation in accordance with embodiments of the present invention. In the example of FIG. 4, dots represent compute nodes (102) of a parallel computer, and the dotted lines between the dots represent data communications links (103) between compute nodes. The data communications links are implemented with point to point data communications adapters similar to the one illustrated for example in FIG. 3A, with data communications links on three axes, x, y, and z, and to and from in six directions +x (181), −x (182), +y (183), −y (184), +z (185), and −z (186). The links and compute nodes are organized by this data communications network optimized for point to point operations into a three dimensional mesh (105). The mesh (105) has wrap-around links on each axis that connect the outermost compute nodes in the mesh (105) on opposite sides of the mesh (105). These wrap-around links form part of a torus (107). Each compute node in the torus has a location in the torus that is uniquely specified by a set of x, y, z coordinates. Readers will note that the wrap-around links in the y and z directions have been omitted for clarity, but are configured in a similar manner to the wrap-around link illustrated in the x direction. For clarity of explanation, the data communications network of FIG. 4 is illustrated with only 27 compute nodes, but readers will recognize that a data communications network optimized for point to point operations for use in executing an allgather operation on a parallel computer in accordance with embodiments of the present invention may contain only a few compute nodes or may contain thousands of compute nodes.

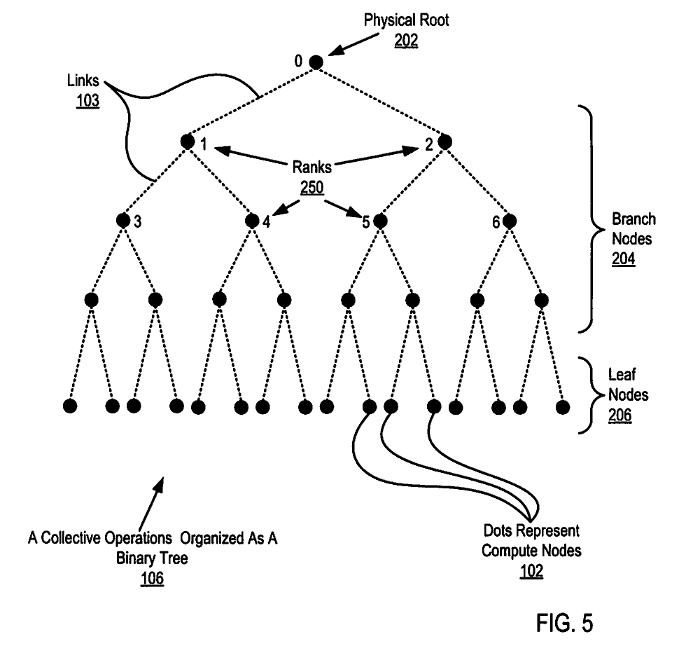

For further explanation, FIG. 5 sets forth a line drawing illustrating an exemplary data communications network (106) optimized for collective operations useful in a parallel computer capable of executing an allgather operation in accordance with embodiments of the present invention. The example data communications network of FIG. 5 includes data communications links connected to the compute nodes so as to organize the compute nodes as a tree. In the example of FIG. 5, dots represent compute nodes (102) of a parallel computer, and the dotted lines (103) between the dots represent data communications links between compute nodes. The data communications links are implemented with global combining network adapters similar to the one illustrated for example in FIG. 3B, with each node typically providing data communications to and from two children nodes and data communications to and from a parent node, with some exceptions. Nodes in a binary tree (106) may be characterized as a physical root node (202), branch nodes (204), and leaf nodes (206). The root node (202) has two children but no parent. The leaf nodes (206) each has a parent, but leaf nodes have no children. The branch nodes (204) each has both a parent and two children. The links and compute nodes are thereby organized by this data communications network optimized for collective operations into a binary tree (106). For clarity of explanation, the data communications network of FIG. 5 is illustrated with only 31 compute nodes, but readers will recognize that a data communications network optimized for collective operations for use in a parallel computer for executing an allgather operation accordance with embodiments of the present invention may contain only a few compute nodes or may contain thousands of compute nodes.

In the example of FIG. 5, each node in the tree is assigned a unit identifier referred to as a ‘rank’ (250). A node's rank uniquely identifies the node's location in the tree network for use in both point to point and collective operations in the tree network. The ranks in this example are assigned as integers beginning with 0 assigned to the root node (202), 1 assigned to the first node in the second layer of the tree, 2 assigned to the second node in the second layer of the tree, 3 assigned to the first node in the third layer of the tree, 4 assigned to the second node in the third layer of the tree, and so on. For ease of illustration, only the ranks of the first three layers of the tree are shown here, but all compute nodes in the tree network are assigned a unique rank.

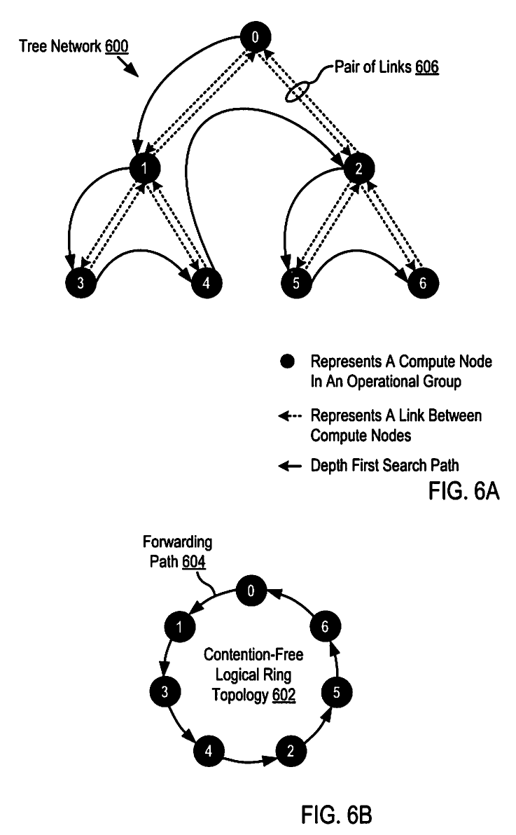

FIG. 6A sets forth a line drawing illustrating an exemplary tree network useful in a parallel computer capable of executing an allgather operation according to embodiments of the present invention. The tree network (600) in the example of FIG. 6A connects the compute nodes ‘0,’ ‘1,’ ‘2,’ ‘3,’ ‘4,’ ‘5,’ and ‘6’ together for data communications. Each child node in the tree network (600) is connected to its parent node through a pair (606) of physical links that provide bi-directional data communications. Each link in the pair (606) of links provides data communications in one direction, either from the parent node to the child node or from the child node to the parent node.

To determine a contention-free logical ring topology for the compute nodes in the tree network (600), the parallel computer performs a depth first search through the tree network (600). A depth first search is an algorithm for traversing a tree structure that explores as far as possible along a branch of the tree until a node with no children is identified and then backtracks returning to the most recently traversed node having another unexplored branch. Consider, for example, the tree network (600) in the example of FIG. 6A in which the parallel computer performs a depth first search through the tree network (600) starting with the compute node ‘0.’ In such an example, the parallel computer traverses from compute node ‘0’ to compute node ‘1’ and then to compute node ‘3.’ Upon reaching compute node ‘3,’ the parallel computer backtracks to compute node ‘1’ and traverses to compute node ‘4.’ Upon reaching compute node ‘4,’ the parallel computer backtracks to compute node ‘0’ and traverses to compute node ‘2.’ The parallel computer then traverses to compute node ‘5.’ Upon reaching compute node ‘5,’ the parallel computer backtracks to compute node ‘2’ and traverses to compute node ‘6.’

After performing a depth first search through the tree network (600), the parallel computer determines a contention-free logical ring topology for the compute nodes in the tree network (600) in the example of FIG. 6A by ordering the compute nodes in the contention-free logical ring topology according to the depth first search. That is, the order in which the parallel computer discovered the compute nodes in the tree network (600) using the depth first search becomes the order of the nodes in the contention free logical ring topology. As mentioned above, a logical ring topology is a network topology in which each of the nodes of the network is logically connected to two other nodes in the network and with the first and last nodes being connected to each other, forming a ring. All data that is transmitted between nodes in the network travels from one node to the next node in a circular manner and the data typically only flows in a single direction. In the example of FIG. 6A, the order in which the parallel computer discovered the compute nodes in the tree network (600) is as follows: compute node ‘0,’ compute node ‘1,’ compute node ‘3,’ compute node ‘4,’ compute node ‘2,’ compute node ‘5,’ and compute node ‘6.’

For further explanation of the contention-free logical ring topology, FIG. 6B sets forth a line drawing illustrating an exemplary contention-free logical ring topology useful in a parallel computer capable of executing an allgather operation according to embodiments of the present invention. The contention-free logical ring topology (602) of FIG. 6B illustrates a logical ring topology determined for the exemplary compute nodes in the tree network (600) of FIG. 6A. The order of the compute nodes in the contention-free logical ring topology is as follows: compute node ‘0,’ compute node ‘1,’ compute node ‘3,’ compute node ‘4,’ compute node ‘2,’ compute node ‘5,’ and compute node ‘6.’

In the example of FIG. 6B, the path between each of the compute nodes in the contention-free logical ring topology (602) is referred to as the forwarding path (604). The forwarding path (604) specifies the physical link in the network that a particular compute node uses to forward data along to the next compute node in the logical ring topology (602). In the example of FIG. 6B, each compute node of the logical ring topology (602) is configured with a routing table to specify the forwarding path (604) for each compute node of the logical ring topology (602).

The logical ring topology (602) of FIG. 6B is referred to as ‘contention-free’ because each physical link connecting the compute nodes in the logical ring topology is only used for data communications by a single pair of compute nodes in one direction at a time. Referring back to FIG. 6A, readers will note that the physical links between each of the compute nodes in the tree network (600) only provide data communications in one direction. Bi-directional data communications between a pair of compute nodes, therefore, is effected using two physical link—one for each direction of data communications. As such, all of the compute nodes in the tree network (600) of FIG. 6A may forward data to the next compute node as specified by the logical ring topology (602) of FIG. 6B concurrently without multiple nodes attempting to use the same physical link.

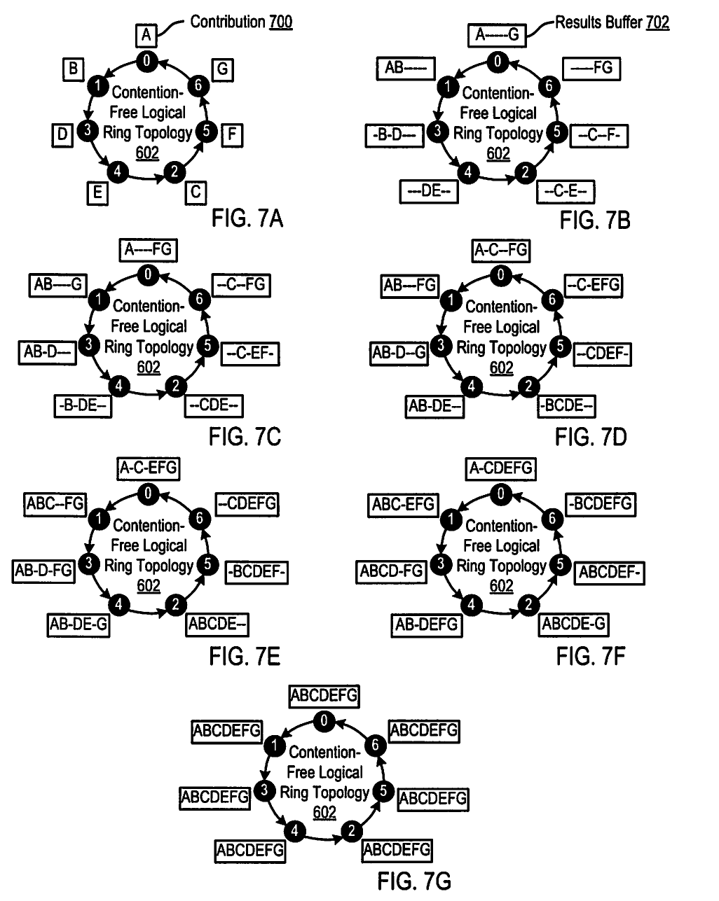

To execute the allgather operation according to embodiments of the present invention, each compute node in the parallel computer repeatedly forwards a contribution for the allgather operation to the next compute node in the contention-free logical ring topology (602) along the forwarding path specified in that compute node's routing table until each compute node in the operational group has received contributions for all of the other compute nodes in the operational group. For further explanation, therefore, FIGS. 7A-G set forth line drawings illustrating exemplary compute nodes that each repeatedly forward a contribution for an allgather operation to the next compute node in the contention-free logical ring topology (602) until each compute node in the operational group has received contributions for all of the other compute nodes in the operational group according to embodiments of the present invention.

In the example of FIG. 7A, the contention-free logical ring topology includes computes nodes ‘0,’ ‘1,’ ‘2,’ ‘3,’ ‘4,’ ‘5,’ and ‘6.’ Each node originates a contribution (700) for the allgather operation. Compute node ‘0’ provides an allgather contribution of ‘A.’ Compute node ‘1’ provides an allgather contribution of ‘B.’ Compute node ‘2’ provides an allgather contribution of ‘C.’ Compute node ‘3’ provides an allgather contribution of ‘D.’ Compute node ‘4’ provides an allgather contribution of ‘E.’ Compute node ‘5’ provides an allgather contribution of ‘F.’ Compute node ‘6’ provides an allgather contribution of ‘G.’ When execution of the allgather operation is initiated, each compute node stores its own contribution in a position of a results buffer that corresponds with the rank of the compute node. For example, compute node ‘0’ stores a value of ‘A’ in position zero of its results buffer, while compute node ‘3’ stores a value of ‘D’ in position three of its results buffer.

In the first iteration of forwarding a contribution for the allgather operation to the next compute node in the contention-free logical ring topology (602), each compute node forwards its own contribution and its own unique rank to the next compute node in the contention-free logical ring topology (602). The next compute node in the logical ring topology (602) then stores the received contribution in a results buffer at the position that corresponds with the rank of the compute node originating the contribution. For further explanation, FIG. 7B illustrates a results buffer (702) for each of the compute nodes after the first iteration of forwarding a contribution for the allgather operation to the next compute node in the contention-free logical ring topology (602). In the example of FIG. 7B, the results buffer (702) for compute node ‘0’ contains ‘A-----G,’ that is the contributions of both compute nodes ‘0’ and ‘6.’ The results buffer (702) for compute node ‘1’ contains ‘AB-----,’ that is the contributions of both compute nodes ‘0’ and ‘1.’ The results buffer (702) for compute node ‘3’ contains ‘-B-D---,’ that is the contributions of both compute nodes ‘1’ and ‘3.’ The results buffer (702) for compute node ‘4’ contains ‘---DE--,’ that is the contributions of both compute nodes ‘3’ and ‘4.’ The results buffer (702) for compute node ‘2’ contains ‘--C-E--,’ that is the contributions of both compute nodes ‘2’ and ‘4.’ The results buffer (702) for compute node ‘5’ contains ‘--C--F-,’ that is the contributions of both compute nodes ‘2’ and ‘5.’ The results buffer (702) for compute node ‘6’ contains ‘-----FG,’ that is the contributions of both compute nodes ‘5’ and ‘6.’

In the second iteration of forwarding a contribution for the allgather operation to the next compute node in the contention-free logical ring topology (602), each compute node forwards the most recently received contribution and the rank of the compute node from which the contribution originated to the next compute node in the contention-free logical ring topology (602). The next compute node in the logical ring topology (602) then stores the received contribution in a results buffer at the position that corresponds with the rank of the compute node originating the contribution. For further explanation, FIG. 7C illustrates a results buffer (702) for each of the compute nodes after the second iteration of forwarding a contribution for the allgather operation to the next compute node in the contention-free logical ring topology (602). In the example of FIG. 7C, the results buffer for compute node ‘0’ contains ‘A----FG,’ that is the contributions of compute nodes ‘0,’ ‘5,’ and ‘6.’ The results buffer for compute node ‘1’ contains ‘AB----G,’ that is the contributions of compute nodes ‘0,’ ‘1,’ and ‘6.’ The results buffer for compute node ‘3’ contains ‘AB-D---,’ that is the contributions of compute nodes ‘0,’ ‘1,’ and ‘3.’ The results buffer for compute node ‘4’ contains ‘-B-DE--,’ that is the contributions of compute nodes ‘1,’ ‘3,’ and ‘4.’ The results buffer for compute node ‘2’ contains ‘--CDE--,’ that is the contributions of compute nodes ‘2,’ ‘3,’ and ‘4.’ The results buffer for compute node ‘5’ contains ‘--C-EF-,’ that is the contributions of compute nodes ‘2,’ ‘4,’ and ‘5.’ The results buffer for compute node ‘6’ contains ‘--C--FG,’ that is the contributions of compute nodes ‘2,’ ‘5,’ and ‘6.’

In the third iteration of forwarding a contribution for the allgather operation to the next compute node in the contention-free logical ring topology (602), each compute node again forwards the most recently received contribution and the rank of the compute node from which the contribution originated to the next compute node in the contention-free logical ring topology (602). The next compute node in the logical ring topology (602) then stores the received contribution in a results buffer at the position that corresponds with the rank of the compute node originating the contribution. For further explanation, FIG. 7D illustrates a results buffer (702) for each of the compute nodes after the third iteration of forwarding a contribution for the allgather operation to the next compute node in the contention-free logical ring topology (602). In the example of FIG. 7D, the results buffer for compute node ‘0’ contains ‘A-C--FG,’ that is the contributions of compute nodes ‘0,’ ‘2,’ ‘5,’ and ‘6.’ The results buffer for compute node ‘1’ contains ‘AB---FG,’ that is the contributions of compute nodes ‘0,’ ‘1,’ ‘5,’ and ‘6.’ The results buffer for compute node ‘3’ contains ‘AB-D--G,’ that is the contributions of compute nodes ‘0,’ ‘1,’ ‘3,’ and ‘6.’ The results buffer for compute node ‘4’ contains ‘AB-DE--,’ that is the contributions of compute nodes ‘0,’ ‘1,’ ‘3,’ and ‘4.’ The results buffer for compute node ‘2’ contains ‘-BCDE--,’ that is the contributions of compute nodes ‘1’ ‘2,’ ‘3,’ and ‘4.’ The results buffer for compute node ‘5’ contains ‘--CDEF-,’ that is the contributions of compute nodes ‘2,’ ‘3,’ ‘4,’ and ‘5.’ The results buffer for compute node ‘6’ contains ‘--C-EFG,’ that is the contributions of compute nodes ‘2,’ ‘4,’ ‘5,’ and ‘6.’

In the fourth iteration of forwarding a contribution for the allgather operation to the next compute node in the contention-free logical ring topology (602), each compute node again forwards the most recently received contribution and the rank of the compute node from which the contribution originated to the next compute node in the contention-free logical ring topology (602). The next compute node in the logical ring topology (602) then stores the received contribution in a results buffer at the position that corresponds with the rank of the compute node originating the contribution. For further explanation, FIG. 7E illustrates a results buffer (702) for each of the compute nodes after the fourth iteration of forwarding a contribution for the allgather operation to the next compute node in the contention-free logical ring topology (602). In the example of FIG. 7E, the results buffer for compute node ‘0’ contains ‘A-C-EFG,’ that is the contributions of compute nodes ‘0,’ ‘2,’ ‘4,’ ‘5,’ and ‘6.’ The results buffer for compute node ‘1’ contains ‘ABC--FG,’ that is the contributions of compute nodes ‘0,’ ‘1,’ ‘2,’ ‘5,’ and ‘6.’ The results buffer for compute node ‘3’ contains ‘AB-D-FG,’ that is the contributions of compute nodes ‘0,’ ‘1,’ ‘3,’ ‘5,’ and ‘6.’ The results buffer for compute node ‘4’ contains ‘AB-DE-G,’ that is the contributions of compute nodes ‘0,’ ‘1,’ ‘3,’ ‘4,’ and ‘6.’ The results buffer for compute node ‘2’ contains ‘ABCDE--,’ that is the contributions of compute nodes ‘0,’ ‘1’ ‘2,’ ‘3,’ and ‘4.’ The results buffer for compute node ‘5’ contains ‘-BCDEF-,’ that is the contributions of compute nodes ‘1,’ ‘2,’ ‘3,’ ‘4,’ and ‘5.’ The results buffer for compute node ‘6’ contains ‘--CDEFG,’ that is the contributions of compute nodes ‘2,’ ‘3,’ ‘4,’ ‘5,’ and ‘6.’

In the fifth iteration of forwarding a contribution for the allgather operation to the next compute node in the contention-free logical ring topology (602), each compute node again forwards the most recently received contribution and the rank of the compute node from which the contribution originated to the next compute node in the contention-free logical ring topology (602). The next compute node in the logical ring topology (602) then stores the received contribution in a results buffer at the position that corresponds with the rank of the compute node originating the contribution. For further explanation, FIG. 7F illustrates a results buffer (702) for each of the compute nodes after the fifth iteration of forwarding a contribution for the allgather operation to the next compute node in the contention-free logical ring topology (602). In the example of FIG. 7F, the results buffer for compute node ‘0’ contains ‘A-CDEFG,’ that is the contributions of compute nodes ‘0,’ ‘2,’ ‘3,’ ‘4,’ ‘5,’ and ‘6.’ The results buffer for compute node ‘1’ contains ‘ABC-EFG,’ that is the contributions of compute nodes ‘0,’ ‘1,’ ‘2,’ ‘4,’ ‘5,’ and ‘6.’ The results buffer for compute node ‘3’ contains ‘ABCD-FG,’ that is the contributions of compute nodes ‘0,’ ‘1,’ ‘2,’ ‘3,’ ‘5,’ and ‘6.’ The results buffer for compute node ‘4’ contains ‘AB-DEFG,’ that is the contributions of compute nodes ‘0,’ ‘1,’ ‘3,’ ‘4,’ ‘5,’ and ‘6.’ The results buffer for compute node ‘2’ contains ‘ABCDE-G,’ that is the contributions of compute nodes ‘0,’ ‘1’ ‘2,’ ‘3,’ ‘4,’ and ‘6.’ The results buffer for compute node ‘5’ contains ‘ABCDEF-,’ that is the contributions of compute nodes ‘0,’ ‘1,’ ‘2,’ ‘3,’ ‘4,’ and ‘5.’ The results buffer for compute node ‘6’ contains ‘-BCDEFG,’ that is the contributions of compute nodes ‘1,’ ‘2,’ ‘3,’ ‘4,’ ‘5,’ and ‘6.’

In the sixth iteration of forwarding a contribution for the allgather operation to the next compute node in the contention-free logical ring topology (602), each compute node again forwards the most recently received contribution and the rank of the compute node from which the contribution originated to the next compute node in the contention-free logical ring topology (602). The next compute node in the logical ring topology (602) then stores the received contribution in a results buffer at the position that corresponds with the rank of the compute node originating the contribution. For further explanation, FIG. 7G illustrates a results buffer (702) for each of the compute nodes after the sixth iteration of forwarding a contribution for the allgather operation to the next compute node in the contention-free logical ring topology (602). In the example of FIG. 7G, the results buffer for each compute node contains ‘ABCDEFG,’ that is the contributions of all of the compute nodes ‘0,’ ‘1,’ ‘2,’ ‘3,’ ‘4,’ ‘5,’ and ‘6.’

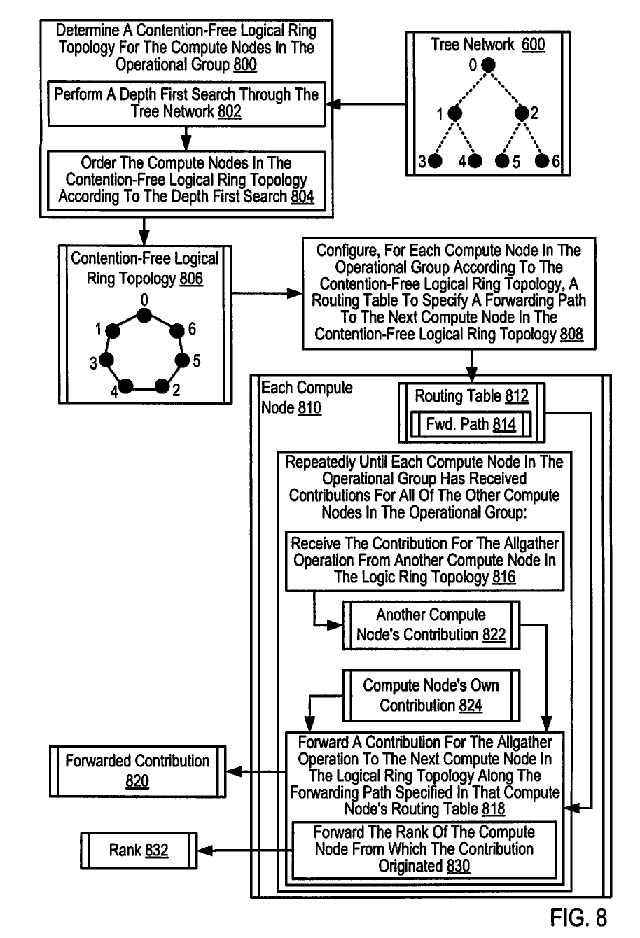

For further explanation, FIG. 8 sets forth a flow chart illustrating an exemplary method for executing an allgather operation on a parallel computer according to the present invention. The parallel computer includes a plurality of compute nodes organized into at least one operational group for collective parallel operations. The compute nodes in the operational group are connected for data communications using a tree network (600). Each compute node in the operational group is assigned a unique rank. In the example of FIG. 8, the tree network (600) connects seven compute nodes having ranks 0, 1, 2, 3, 4, 5, and 6 for data communications.

The method of FIG. 8 includes determining (800) a contention-free logical ring topology (806) for the compute nodes (810) in the operational group. Determining (800) a contention-free logical ring topology (806) for the compute nodes (810) in the operational group according to the method of FIG. 8 includes performing (802) a depth first search through the tree network (600) and ordering (804) the compute nodes in the contention-free logical ring topology (806) according to the depth first search as discussed above with reference to FIGS. 6A and 6B. Determining (800) a contention-free logical ring topology (806) for the compute nodes (810) in the operational group according to the method of FIG. 8 may be carried out by a service node of the parallel computer or by each compute node itself. A service node typically determines (800) the contention-free logical ring topology (806) for the compute nodes (810) in the operational group according to the method of FIG. 8 because the service node maintains a graph of the tree network (600) used by the depth first search algorithm to construct the logical ring topology (806). Readers will note, however, that any computing device having access to a graph of the tree network (600) may carry out determining (800) a contention-free logical ring topology (806) for the compute nodes (810) in the operational group according to the method of FIG. 8, including each compute node in the operational group.

The method of FIG. 8 also includes configuring (808), for each compute node (810) in the operational group according to the contention-free logical ring topology (806), a routing table (812) to specify a forwarding path (814) to the next compute node in the contention-free logical ring topology (806). The routing table (812) of FIG. 8 represents a data structure or register for storing routing information in a compute node (810). The forwarding path (814) of FIG. 8 specifies the physical link in the network that each compute node (810) uses to forward data along to the next compute node in the logical ring topology (806). The forwarding path (814) of FIG. 8 may be specified in the routing table (812) using a class route. Configuring (808) a routing table (812) for each compute node (810) to specify a forwarding path (814) to the next compute node in the contention-free logical ring topology (806) according to the logical ring topology (806) in the method of FIG. 8 may be carried out by setting the next compute node in the logical ring topology (806) as the destination node in the routing table (812) for a class routing identifier designated for the logical ring topology (806). A class routing identifier allows each compute node (810) to identify the routing instructions for a particular logical network topology. Typically, as network packets arrive in each compute node (810), the compute node (810) identifies the particular class routing identifier for each packet. The compute node (810) then routes each particular packet according to the routing instructions for each packet's class routing identifier. In such a manner, the class routing identifier designated for the logical ring topology (806) may be used by each compute node to identify when to route data communications among nodes according to the contention-free logical ring topology (806). Readers will note that configuring (808) a routing table (812) for each compute node (810) to specify a forwarding path (814) to the next compute node in the contention-free logical ring topology (806) according to the logical ring topology (806) in the method of FIG. 8 may be carried out by the service node of the parallel computer or by each compute node (810) itself.

For further explanation of configuring (808) a routing table (812) for each compute node (810) to specify a forwarding path (814) to the next compute node in the contention-free logical ring topology (806) according to the logical ring topology (806) in the method of FIG. 8, consider an exemplary routing table for the compute node of rank ‘0’ in the example of FIG. 8:

EXEMPLARY ROUTING TABLE 1

| CLASS | DESTINATION |
|---|---|
| ROUTING ID | NODES |
| 0 | 1 & 2 |
| 1 | 1 |
| . . . | . . . |

The exemplary routing table 1 above illustrates routing instructions for two exemplary class routes for two different logical network topologies that utilize the physical tree network (600) for data communications. The first exemplary class route provides compute node ‘0’ with routing instructions for a logical tree network topology and is identified in the exemplary routing table 1 above by a class routing identifier of ‘0.’ The first exemplary class route instructs the compute node of rank ‘0’ to forward data to compute nodes of rank ‘1’ and ‘2.’ The second exemplary class route provides compute node ‘0’ with routing instructions for the contention-free logical ring network topology (806) and is identified in the exemplary routing table 0 above by a class routing identifier of ‘1.’ The second exemplary class route instructs the compute node of rank ‘0’ to forward data only to compute node of rank ‘1.’ Readers will note that the exemplary routing table 1 above is for explanation only and not for limitation. Other routing tables as will occur to those of skill in the may also be useful in executing an allgather operation on a parallel computer according to embodiments of the present invention.

For further explanation, consider an exemplary routing table for the compute node of rank ‘3’ in the example of FIG. 8:

EXEMPLARY ROUTING TABLE 2

| CLASS | DESTINATION |
|---|---|
| ROUTING ID | NODES |
| 0 | 1 |
| 1 | 4 |
| . . . | . . . |

The exemplary routing table 2 above illustrates routing instructions for two exemplary class routes for two different logical network topologies that utilize the physical tree network (600) for data communications. The first exemplary class route provides compute node ‘3’ with routing instructions for a logical tree network topology and is identified in the exemplary routing table 2 above by a class routing identifier of ‘0.’ The first exemplary class route instructs the compute node of rank ‘0’ to forward data to the compute node of rank ‘1.’ The second exemplary class route provides compute node ‘3’ with routing instructions for the contention-free logical ring network topology (806) and is identified in the exemplary routing table 2 above by a class routing identifier of ‘1.’ The second exemplary class route instructs the compute node of rank ‘3’ to forward data only to compute node of rank ‘4.’ Readers will note that the exemplary routing table 2 above is for explanation only and not for limitation. Other routing tables as will occur to those of skill in the may also be useful in executing an allgather operation on a parallel computer according to embodiments of the present invention.

The method of FIG. 8 also includes repeatedly, for each compute node (810) in the operational group until each compute node (810) in the operational group has received contributions for all of the other compute nodes in the operational group, forwarding (818) a contribution (820) for the allgather operation to the next compute node in the contention-free logical ring topology (806) along the forwarding path (814) specified in that compute node's routing table (812) and receiving (816) a contribution (822) for the allgather operation from another compute node in the contention-free logic ring topology (806). Each compute node may forward (818) and receive (816) contributions through a global combining network adapter such as the one described above with reference to FIG. 3B. As mentioned above, each compute node (810) may initially forward (818) a contribution (820) for the allgather operation to the next compute node in the contention-free logical ring topology (806) according to the method of FIG. 8 by forwarding the compute node's own contribution (824) for the allgather operation. After receiving (816) a contribution (822) for the allgather operation from another compute node in the contention-free logic ring topology (806), each compute node (810) may forward (818) a contribution (820) for the allgather operation to the next compute node in the contention-free logical ring topology (806) according to the method of FIG. 8 by forwarding another compute node's contribution (822) for the allgather operation.

In the method of FIG. 8, forwarding (818) a contribution (820) for the allgather operation to the next compute node in the contention-free logical ring topology (806) includes forwarding (830) the rank (832) of the compute node from which the contribution (820) originated to the next compute node in the contention-free logical ring network topology (806). When forwarding the compute node's own contribution (824), the compute node (810) may forward (830) its own rank to the next compute node in the contention-free logical ring network topology. When forwarding another compute node's contribution (822), the compute node (810) may forward (830) the rank of the compute node originating the contribution (822) to the next compute node in the contention-free logical ring network topology. Forwarding (830) the rank (832) of the compute node from which the contribution (820) originated to the next compute node in the contention-free logical ring network topology (806) allows each compute node (810) to store the contribution from each of the other compute nodes in the proper position in the results buffer that contains the results of the allgather operation.

Exemplary embodiments of the present invention are described largely in the context of a fully functional computer system for executing an allgather operation on a parallel computer. Readers of skill in the art will recognize, however, that the present invention also may be embodied in a computer program product disposed on computer readable media for use with any suitable data processing system. Such computer readable media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for executing an allgather operation on a parallel computer, the parallel computer comprising a plurality of compute nodes, the compute nodes organized into at least one operational group of compute nodes for collective parallel operations, each compute node in the operational group assigned a unique rank, the method further comprising:
determining a contention-free logical ring topology for the compute nodes in the operational group;
configuring, for each compute node in the operational group according to the contention-free logical ring topology, a routing table to specify a forwarding path to the next compute node in the contention-free logical ring topology; and
repeatedly, for each compute node in the operational group until each compute node in the operational group has received contributions for all of the other compute nodes in the operational group, forwarding a contribution for the allgather operation to the next compute node in the contention-free logical ring topology along the forwarding path specified in that compute node's routing table.

2. The method of claim 1 wherein the contribution forwarded to the next compute node in the logical ring topology along the forwarding path is the compute node's own contribution for the allgather operation.

3. The method of claim 1 wherein the contribution forwarded to the next compute node in the logical ring topology along the forwarding path is another compute node's contribution for the allgather operation.

4. The method of claim 1 wherein forwarding a contribution for the allgather operation to the next compute node in the contention-free logical ring topology further comprises forwarding the rank of the compute node from which the contribution originated to the next compute node in the contention-free logical ring network topology.

5. The method of claim 1 wherein:
the compute nodes in the operational group are connected for data communications using a tree network; and
determining a contention-free logical ring topology for the compute nodes in the operational group further comprises:
performing a depth first search through the tree network, and
ordering the compute nodes in the contention-free logical ring topology according to the depth first search.

6. The method of claim 1 wherein the plurality of compute nodes are connected for data communications through a plurality of data communications networks, at least one of the data communications networks optimized for point to point data communications, and at least one of the data communications networks optimized for collective operations.

7. A parallel computer for executing an allgather, the parallel computer comprising a plurality of compute nodes, the compute nodes organized into at least one operational group of compute nodes for collective parallel operations, each compute node in the operational group assigned a unique rank, the parallel computer comprising computer memory operatively coupled to each compute node, the computer memory having disposed within it computer program instructions capable of:
determining a contention-free logical ring topology for the compute nodes in the operational group;
configuring, for each compute node in the operational group according to the contention-free logical ring topology, a routing table to specify a forwarding path to the next compute node in the contention-free logical ring topology; and
repeatedly, for each compute node in the operational group until each compute node in the operational group has received contributions for all of the other compute nodes in the operational group, forwarding a contribution for the allgather operation to the next compute node in the contention-free logical ring topology along the forwarding path specified in that compute node's routing table.

8. The parallel computer of claim 7 wherein the contribution forwarded to the next compute node in the logical ring topology along the forwarding path is the compute node's own contribution for the allgather operation.

9. The parallel computer of claim 7 wherein the contribution forwarded to the next compute node in the logical ring topology along the forwarding path is another compute node's contribution for the allgather operation.

10. The parallel computer of claim 7 wherein forwarding a contribution for the allgather operation to the next compute node in the contention-free logical ring topology further comprises forwarding the rank of the compute node from which the contribution originated to the next compute node in the contention-free logical ring network topology.

11. The parallel computer of claim 7 wherein:
the compute nodes in the operational group are connected for data communications using a tree network; and
determining a contention-free logical ring topology for the compute nodes in the operational group further comprises:
performing a depth first search through the tree network, and
ordering the compute nodes in the contention-free logical ring topology according to the depth first search.

12. The parallel computer of claim 7 wherein the plurality of compute nodes are connected for data communications through a plurality of data communications networks, at least one of the data communications networks optimized for point to point data communications, and at least one of the data communications networks optimized for collective operations.

13. A computer program product for executing an allgather operation on a parallel computer, the parallel computer comprising a plurality of compute nodes, the compute nodes organized into at least one operational group of compute nodes for collective parallel operations, each compute node in the operational group assigned a unique rank, the computer program product disposed upon a computer readable medium, the computer program product comprising computer program instructions capable of:
determining a contention-free logical ring topology for the compute nodes in the operational group;
configuring, for each compute node in the operational group according to the contention-free logical ring topology, a routing table to specify a forwarding path to the next compute node in the contention-free logical ring topology; and
repeatedly, for each compute node in the operational group until each compute node in the operational group has received contributions for all of the other compute nodes in the operational group, forwarding a contribution for the allgather operation to the next compute node in the contention-free logical ring topology along the forwarding path specified in that compute node's routing table.

14. The computer program product of claim 13 wherein the contribution forwarded to the next compute node in the logical ring topology along the forwarding path is the compute node's own contribution for the allgather operation.

15. The computer program product of claim 13 wherein the contribution forwarded to the next compute node in the logical ring topology along the forwarding path is another compute node's contribution for the allgather operation.

16. The computer program product of claim 13 wherein forwarding a contribution for the allgather operation to the next compute node in the contention-free logical ring topology further comprises forwarding the rank of the compute node from which the contribution originated to the next compute node in the contention-free logical ring network topology.

17. The computer program product of claim 13 wherein:
the compute nodes in the operational group are connected for data communications using a tree network; and
determining a contention-free logical ring topology for the compute nodes in the operational group further comprises:
performing a depth first search through the tree network, and
ordering the compute nodes in the contention-free logical ring topology according to the depth first search.

18. The computer program product of claim 13 wherein the plurality of compute nodes are connected for data communications through a plurality of data communications networks, at least one of the data communications networks optimized for point to point data communications, and at least one of the data communications networks optimized for collective operations.

19. The computer program product of claim 13 wherein the computer readable medium comprises a recordable medium.

20. The computer program product of claim 13 wherein the computer readable medium comprises a transmission medium.
